(19) United States
(12) Patent Application Publication
(10) Pub. No.: US 2026/0329796 A1
(43) Pub. Date: Oct. 22, 2026

(54) SWITCHING SYSTEM, USB HUB DEVICE AND OPERATION METHOD THEREOF

(71) Applicant: VIA LABS, INC., New Taipei City (TW)

(72) Inventors: Cheng-Ming Huang, New Taipei City (TW); SzuLien Chu, New Taipei City (TW); BoMing Huang, New Taipei City (TW)

(73) Assignee: VIA LABS, INC., New Taipei City (TW)

(21) Appl. No.: 19/322,700

(22) Filed: Sep. 9, 2025

(30) Foreign Application Priority Data
Apr. 17, 2025 (TW) 114114651

(51) Int. Cl. G06F 13/40; G06F 13/38; G06F 13/42

(52) U.S. Cl. CPC G06F 13/4022; G06F 13/382; G06F 13/4282; G06F 2213/0042

(57) ABSTRACT

A switching system, a USB hub device and an operation method thereof are provided. The switching system includes the USB hub device and a first host. In response to the first host determining that a human interface device operation event meets a condition, the first host selectively sends a switching command to the USB hub device. Based on the switching command sent by the first host, the USB hub device terminates a connection to the first host and establishes a connection to a second host.

### CROSS-REFERENCE TO RELATED APPLICATION

This application claims the priority benefit of Taiwan application serial no. 114114651, filed on Apr. 17, 2025. The entirety of the above-mentioned patent application is hereby incorporated by reference herein and made a part of this specification.

### BACKGROUND

### Technical Field

The disclosure relates to an electronic equipment, and more particularly to a switching system, a universal serial bus (USB) hub device, and an operation method thereof.

### Description of Related Art

A universal serial bus (USB) is a data transmission interface for connecting a host and a device. Today, computers, mobile phones, or other electronic products all have USB interfaces. A USB architecture has only one USB host, and other electronic devices are USB devices. The USB device may include a human interface device (HID), a solid-state drive (SSD), a USB hub device, or other peripheral devices. The HID device may include a keyboard, a mouse, or other equipment. A USB hub device may allow multiple USB devices to be connected to the same USB connector of the host.

A general USB hub device has just one USB upstream facing port (UFP) connector to be connected to a USB downstream facing port (DFP) connector of a host (or another USB hub device). To switch a connection of a USB hub device connected to many USB devices from one host to another host, the general technique is to manually unplug the USB UFP connector of the USB hub device from the original host, and then plug the USB UFP connector of the USB hub device to another host. How to allow multiple USB hosts to share the same USB hub device and the resources thereof in a time-sharing manner is one of the many technical issues in the USB field.

### SUMMARY

The disclosure provides a switching system, a universal serial bus (USB) hub device, and an operation method thereof, allowing a same USB hub device to be selectively shared by a plurality of hosts.

In an embodiment of the disclosure, the switching system includes a USB hub device and a first host. The USB hub device includes a plurality of upstream facing port connectors and a plurality of downstream facing port connectors. The plurality of upstream facing port connectors are configured to couple a plurality of different hosts. Each of the plurality of downstream facing port connectors is configured to couple a human interface device, a USB device, or another USB hub device. The first host is coupled to a first upstream facing port connector of the plurality of upstream facing port connectors of the USB hub device. In response to the first host determining that a human interface device operation event meets a condition, the first host selectively sends a first switching command to the USB hub device. Based on the first switching command sent by the first host, a connection to the first host is terminated by the USB hub device and a connection to a second host is established by the USB hub device. The second host is coupled to a second upstream facing port connector of the plurality of upstream facing port connectors of the USB hub device.

In an embodiment of the disclosure, an operation method of a switching system includes the following steps. In response to a first host determining that a human interface device operation event meets a condition, the first host of the switching system selectively sends a first switching command to a USB hub device of the switching system. Based on the first switching command sent by the first host, the USB hub device terminates a connection to the first host and establishes a connection to a second host.

In an embodiment of the disclosure, a USB hub device includes a plurality of upstream facing port connectors, a plurality of downstream facing port connectors, a multiplexer circuit, and a hub controller. The plurality of upstream facing port connectors are configured to couple a plurality of different hosts. Each of the plurality of downstream facing port connectors is configured to couple a human interface device, a USB device, or another USB hub device. A plurality of USB selection ports of the multiplexer circuit are one-to-one coupled to the plurality of upstream facing port connectors. An upstream facing port of the hub controller is coupled to a USB common port of the multiplexer circuit. A plurality of downstream facing ports of the hub controller are one-to-one coupled to the plurality of downstream facing port connectors. The hub controller controls the multiplexer circuit to selectively couple one of the plurality of upstream facing port connectors to the upstream facing port of the hub controller. In response to a first host coupled to a first upstream facing port connector of the plurality of upstream facing port connectors sending a first switching command to the hub controller through the multiplexer circuit, the hub controller controls the multiplexer circuit based on the first switching command to terminate a connection between the first host and the hub controller, and the hub controller controls the multiplexer circuit to attempt to establish a connection to a second host through a second upstream facing port connector of the plurality of upstream facing port connectors. In response to the connection to the second host being successfully established, the hub controller is controlled by the connected second host. In response to the connection to the second host being unsuccessfully established, the hub controller controls the multiplexer circuit to restore the connection between the first host and the hub controller.

In an embodiment of the disclosure, an operation method of a USB hub device includes the following steps. A hub controller of the USB hub device controls a multiplexer circuit of the USB hub device to selectively couple one of a plurality of upstream facing port connectors of the USB hub device to an upstream facing port of the hub controller. In response to a first host coupled to one of the plurality of upstream facing port connectors sending a first switching command to the hub controller through the multiplexer circuit, the hub controller controls the multiplexer circuit based on the first switching command to terminate a connection between the first host and the hub controller, and controls the multiplexer circuit to attempt to establish a connection to a second host through a second upstream facing port connector. In response to the connection to the second host being successfully established, the hub controller is controlled by the connected second host. In response to the connection to the second host being unsuccessfully established, the hub controller controls the multiplexer circuit to restore the connection between the first host and the hub controller.

Based on the above, in the embodiments of the disclosure, the USB hub device includes a plurality of upstream facing port connectors and a plurality of downstream facing port connectors, and the plurality of upstream facing port connectors are configured to couple a plurality of different hosts. Therefore, resources (such as a human interface device, a USB device, or another USB hub device) coupled to the plurality of downstream facing port connectors may be selectively shared to a plurality of hosts. The USB hub device may establish a connection to one of the plurality of hosts, and the connected host (such as the first host) may determine whether a human interface device operation event meets a condition. In response to the first host determining that the human interface device operation event meets the condition, the first host selectively sends a switching command to the USB hub device to trigger the USB hub device to terminate the connection to the first host and establish a connection to another host (such as the second host). Therefore, a user may switch connections of a plurality of USB devices connected to the USB hub device from one host to another host without manually plugging and unplugging the USB connectors.

To make the features and advantages of the disclosure more comprehensible, several embodiments accompanied with drawings are described in detail as follows.

### BRIEF DESCRIPTION OF THE DRAWINGS

FIG. 1 is a circuit block diagram of a switching system according to an embodiment of the disclosure.

FIG. 2 is a flowchart of an operation method of a switching system according to an embodiment of the disclosure.

FIG. 3 is a schematic diagram of a connection structure of a USB hub device according to another application scenario of the disclosure.

FIG. 4 is a circuit block diagram of a USB hub device according to an embodiment of the disclosure.

FIG. 5 is a flowchart of an operation method of a USB hub device according to an embodiment of the disclosure.

FIG. 6 is a circuit block diagram of a USB hub device according to another embodiment of the disclosure.

FIG. 7 is a flowchart of an operation method of a USB hub device according to another embodiment of the disclosure.

FIG. 8 is a flowchart of an operation method of a host according to an embodiment of the disclosure.

### DESCRIPTION OF THE EMBODIMENTS

The term “coupling (or connecting)” used throughout the specification of this disclosure (including the claims) may refer to any direct or indirect connection means. For example, if the text describes that the first device is coupled (or connected) to the second device, it should be interpreted as that the first device may be directly connected to the second device, or the first device may be indirectly connected to the second device through other devices or some kind of connection means. The terms “first” and “second” mentioned throughout the specification of this disclosure (including the claims) serve to name elements or to distinguish different embodiments or ranges, and not to limit the upper or lower bound of the number of elements nor to limit the sequence of elements. In addition, wherever possible, elements/components/steps using the same reference numerals in the drawings and embodiments refer to the same or similar parts. Cross-reference may be made to related descriptions for elements/components/steps using the same reference numerals or using the same terms in different embodiments.

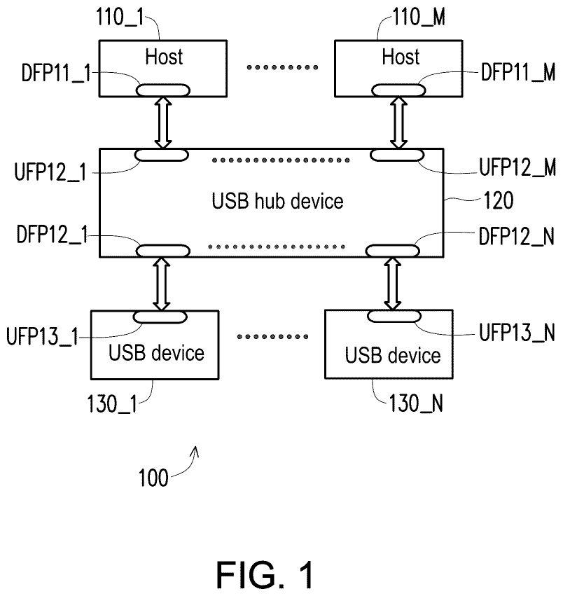

FIG. 1 is a circuit block diagram of a switching system 100 according to an embodiment of the disclosure. The switching system 100 shown in FIG. 1 includes at least one host (for example, hosts 110_1, . . . , 110_M) and a universal serial bus (USB) hub device 120. The USB hub device 120 includes a plurality of USB connectors, for example, upstream facing port (UFP) connectors UFP12_1, . . . , UFP12_M and a plurality of downstream facing port (DFP) connectors DFP12_1, . . . , DFP12_N. A number M of the UFP connectors UFP12_1 to UFP12_M and a number N of the DFP connectors DFP12_1 to DFP12_N may be any integers determined based on an actual design. Based on an actual design and application, each of the UFP connectors UFP12_1 to UFP12_M and the DFP connectors DFP12_1 to DFP12_N may be a type-A connector, a type-C connector, or another USB connector.

Each of the DFP connectors DFP12_1 to DFP12_N is configured to couple a human interface device (HID), a USB device, or another USB hub device. For example, in the application scenario shown in FIG. 1, the DFP connector DFP12_1 is coupled to a UFP connector UFP13_1 of a USB device 130_1, and the DFP connector DFP12_N is coupled to a UFP connector UFP13_N of a USB device 130_N. Any one of the USB devices 130_1 to 130_N may be a human interface device having a USB connector, for example, a mouse or a keyboard.

The UFP connectors UFP12_1 to UFP12_M are configured to couple different hosts. For example, a DFP connector DFP11_1 of the host 110_1 is coupled to the UFP connector UFP12_1 of the USB hub device 120. By analogy, a DFP connector DFP11_M of the host 110_M is coupled to the UFP connector UFP12_M of the USB hub device 120. Based on an actual application, any one of the hosts 110_1 to 110_M may be a smartphone, a tablet, a notebook computer, or another USB host having a USB connector. The resources coupled to the DFP connectors DFP12_1 to DFP12_N may be selectively shared to any one of the hosts 110_1 to 110_M.

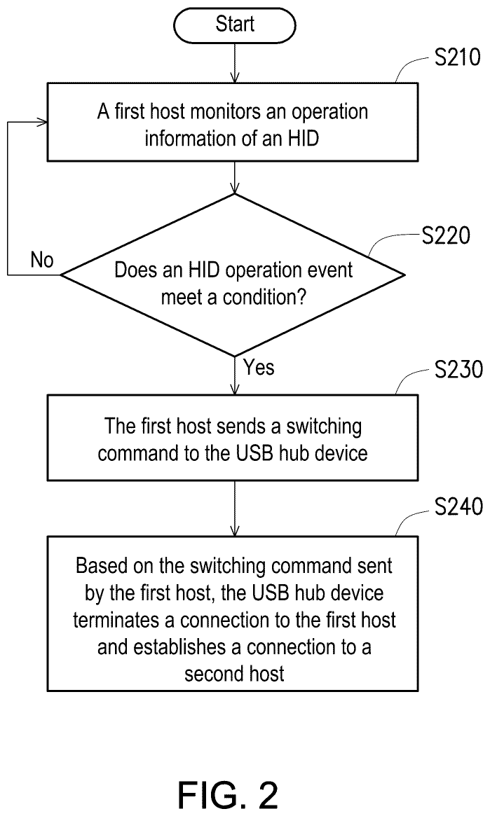

FIG. 2 is a flowchart of an operation method of a switching system according to an embodiment of the disclosure. Referring to FIGS. 1 and 2, it is assumed that the host currently connected to the USB hub device 120 is the host 110_1, and the USB device 130_1 is a human interface device. When a connection to the host 110_1 is established, the USB hub device 120 provides an operation information of the human interface device 130_1, which is coupled to one of the DFP connectors DFP12_1 to DFP12_N, to the host 110_1.

In step S210, software running on the host 110_1 monitors an operation information of a human interface device (HID, for example, the USB device 130_1) coupled to one of the DFP connectors DFP12_1 to DFP12_N of the USB hub device 120. In step S220, the host 110_1 determines whether a human interface device (HID) operation event meets a condition. For example, in response to a user performing a specified operation (such as a specific operation method of at least one hotkey of a mouse or a keyboard) on a human interface device coupled to one of the DFP connectors DFP12_1 to DFP12_N of the USB hub device 120, the software running on the host 110_1 may determine that the HID operation event of the USB device 130_1 meets the condition. The condition may be defined according to an actual design and application. In some embodiments, the software running on the host 110_1 may provide a human-machine interface to the user, allowing the user to set the condition. For example, the condition may be (but not limited to) “both left and right mouse buttons being held down at the same time for three seconds,” “the right mouse button being pressed continuously for three seconds,” “a certain key of the keyboard (this key may be defined by the user) being tapped three times within one second,” “multiple combination keys of the keyboard (for example, A+S+D) being pressed continuously for four seconds,” or other conditions.

In response to a host currently connected to the USB hub device 120 (for example, the host 110_1) determining that the HID operation event does not meet the condition (the determination result of step S220 is “no”), the software running on the host 110_1 returns to step S210 to continue monitoring the operation information of the HID (for example, the USB device 130_1). In response to the host 110_1 currently connected to the USB hub device 120 determining that the HID operation event meets the condition (the determination result of step S220 is “yes”), the host 110_1 selectively sends a switching command to the USB hub device 120 (step S230). Based on the switching command sent by the host 110_1, in step S240, the USB hub device 120 terminates the connection to the host 110_1, and the USB hub device 120 establishes a connection to another host (for example, the host 110_M).

For example, in some embodiments, based on the switching command sent by the host 110_1, the USB hub device 120 checks whether any other UFP connector other than the UFP connector UFP12_1 of the UFP connectors UFP12_1 to UFP12_M is coupled to another host. In response to another host being coupled to another UFP connector of the USB hub device 120 (for example, the host 110_M being coupled to the UFP connector UFP12_M), the USB hub device 120 terminates the connection to the host 110_1 based on the switching command sent by the host 110_1 and establishes a connection to another host (for example, the host 110_M). In response to no host being coupled to any UFP connector other than the UFP connector UFP12_1 of the UFP connectors UFP12_1 to UFP12_M of the USB hub device 120, the USB hub device 120 maintains the connection between the host 110_1 and the UFP connector UFP12_1.

In some other embodiments, based on the switching command sent by the host currently connected to the USB hub device 120 (for example, the host 110_1), the USB hub device 120 terminates the connection between the host 110_1 and the UFP connector UFP12_1, and attempts to establish a connection to another host through a next UFP connector. In response to the connection to another host (for example, the host 110_M) being successfully established, the USB hub device 120 is then controlled by the connected host 110_M. In response to the connection to another host being unsuccessfully established, the USB hub device 120 restores the connection between the original host (for example, the host 110_1) and the UFP connector.

In summary, the USB hub device 120 has multiple UFP connectors UFP12_1 to UFP12_M coupled to different hosts. Resources (for example, a human interface device, a USB device, or another USB hub device) coupled to the DFP connectors DFP12_1 to DFP12_N may be selectively shared to multiple hosts (for example, the hosts 110_1 to 110_M). Specifically, the USB hub device 120 may establish a connection to any one of the multiple hosts 110_1 to 110_M, and the connected host (for example, the host 110_1) may determine whether a HID operation event meets a condition. For example, it is assumed that the USB device 130_1 is a mouse, and the condition is “the right mouse button being pressed continuously for three seconds.” The user may press and hold the right button of the USB device 130_1 (mouse) for more than three seconds. The host 110_1 may detect a HID operation event of the USB device 130_1 through the USB hub device 120 to determine whether the HID operation event of the USB device 130_1 (mouse) meets the condition. In response to the host 110_1 determining that the HID operation event of the USB device 130_1 meets the condition, the host 110_1 selectively sends a switching command to the USB hub device 120 to trigger the USB hub device 120 to terminate the connection to the host 110_1 and establish a connection to another host (for example, the host 110_M). Therefore, the user does not need to manually plug or unplug the USB connector in order to switch the connection of multiple USB devices connected to the USB hub device 120 from one host to another host.

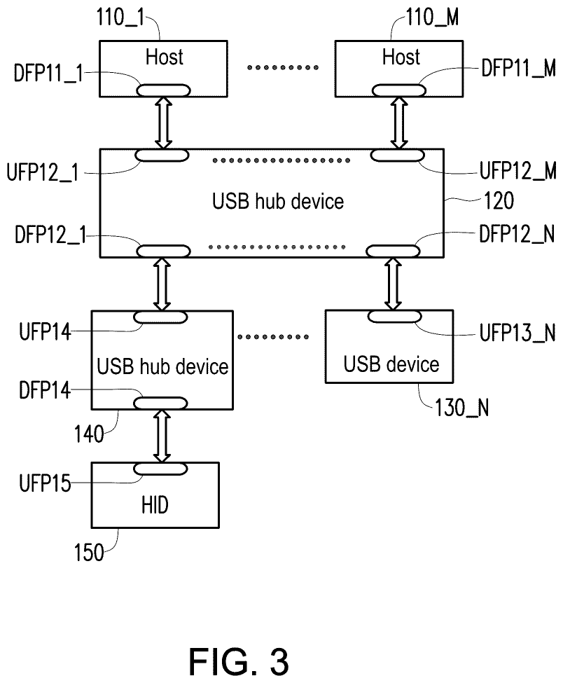

FIG. 3 is a schematic diagram of a connection structure of the USB hub device 120 in another application scenario according to the disclosure. The hosts 110_1 to 110_M, the USB hub device 120, the DFP connectors DFP12_1 to DFP12_N, and the USB device 130_N shown in FIG. 3 may refer to the related description of FIG. 1 and will not be redundantly described herein. In the application scenario shown in FIG. 3, the DFP connector DFP12_1 of the USB hub device 120 is coupled to a UFP connector UFP14 of another USB hub device 140, and a UFP connector UFP15 of a human interface device (HID) 150 is coupled to a DFP connector DFP14 of the USB hub device 140.

It is assumed that the USB hub device 120 currently establishes a connection to the host 110_M. The connected host 110_M may detect a HID operation event of a human interface device (HID) 150 through the USB hub device 120 to determine whether the HID operation event of the HID 150 meets the condition. For example, it is assumed that the HID 150 is a mouse, and the condition is “the right mouse button being pressed continuously for three seconds.” The user may press and hold the right button of the HID 150 (mouse) for more than three seconds. The host 110_M may detect a HID operation event of the HID 150 through the USB hub devices 120 and 140 to determine whether the HID operation event of the HID 150 (mouse) meets the condition. In response to the host 110_M determining that the HID operation event of the HID 150 meets the condition, the host 110_M selectively sends a switching command to the USB hub device 120 to trigger the USB hub device 120 to terminate the connection to the host 110_M and establish a connection to another host (for example, the host 110_1). Therefore, the user does not need to manually plug or unplug the USB connector in order to switch the connection of multiple USB devices connected to the USB hub device 120 from one host to another host.

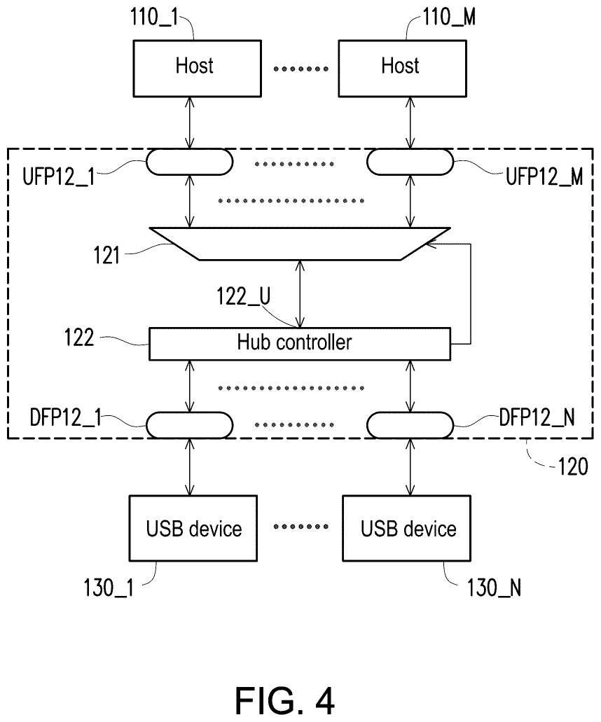

FIG. 4 is a schematic diagram of a circuit block of a USB hub device 120 according to an embodiment of the disclosure. The hosts 110_1 to 110_M, the USB hub device 120, and the USB devices 130_1 to 130_N shown in FIG. 4 may refer to the related description of FIG. 1 and will not be redundantly described herein. The USB hub device 120 shown in FIG. 4 may be one of various embodiments of the USB hub device 120 shown in FIG. 1. In the embodiment shown in FIG. 4, the USB hub device 120 includes the UFP connectors UFP12_1 to UFP12_M, the DFP connectors DFP12_1 to DFP12_N, a multiplexer circuit 121, and a hub controller 122. The UFP connectors UFP12_1 to UFP12_M and the DFP connectors DFP12_1 to DFP12_N shown in FIG. 4 may refer to the related description of FIG. 1 and will not be redundantly described herein. According to different designs, in some embodiments, the multiplexer circuit 121 and/or the hub controller 122 may be implemented as a hardware circuit. In other embodiments, the multiplexer circuit 121 and/or the hub controller 122 may be implemented in a combined form of multiple items including hardware, firmware, and software (i.e., program).

In terms of hardware form, the above multiplexer circuit 121 and/or the hub controller 122 may be implemented as logic circuits on an integrated circuit. For example, the related functions of the multiplexer circuit 121 and/or the hub controller 122 may be implemented in one or more hardware controllers, microcontrollers, hardware processors, microprocessors, application-specific integrated circuits (ASICs), digital signal processors (DSPs), field programmable gate arrays (FPGAs), central processing units (CPUs), and/or various logic blocks, modules, and circuits in other processing units. The related functions of the multiplexer circuit 121 and/or the hub controller 122 may be implemented as hardware circuits by using hardware description languages (for example, Verilog HDL or VHDL) or other appropriate programming languages, such as various logic blocks, modules, and circuits in integrated circuits.

In terms of software form and/or firmware form, the related functions of the above multiplexer circuit 121 and/or the hub controller 122 may be implemented as programming codes. For example, the multiplexer circuit 121 and/or the hub controller 122 may be implemented by using general programming languages (for example, C, C++, or assembly language) or other appropriate programming languages. The programming codes may be recorded/stored in a non-transitory machine-readable storage medium. In some embodiments, the non-transitory machine-readable storage medium includes, for example, a semiconductor memory and/or a storage device. An electronic equipment (for example, a computer, a CPU, a hardware controller, a microcontroller, a hardware processor, or a microprocessor) may read and execute the programming codes from the non-transitory machine-readable storage medium, thereby implementing the related functions of the multiplexer circuit 121 and/or the hub controller 122.

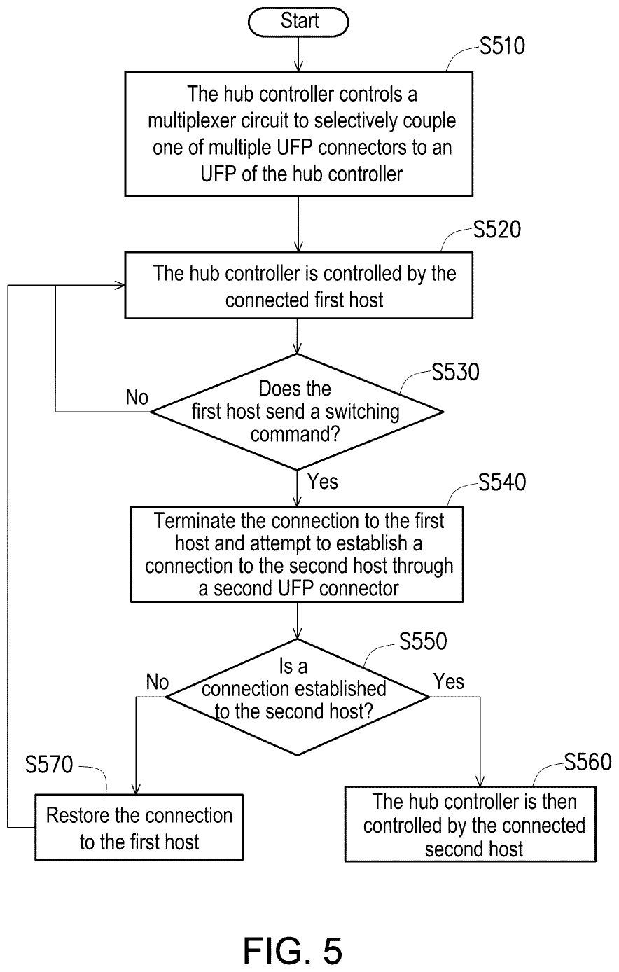

FIG. 5 is a flowchart of an operation method of a USB hub device 120 according to an embodiment of the disclosure. Referring to FIGS. 4 and 5, a plurality of USB selection ports of a multiplexer circuit 121 are one-to-one coupled to UFP connectors UFP12_1 to UFP12_M. An upstream facing port 122_U of a hub controller 122 is coupled to a USB common port of the multiplexer circuit 121. In step S510, the hub controller 122 controls the multiplexer circuit 121 to selectively couple one of the UFP connectors UFP12_1 to UFP12_M to the upstream facing port 122_U of the hub controller 122. A plurality of downstream facing ports of the hub controller 122 are one-to-one coupled to DFP connectors DFP12_1 to DFP12_N.

Here, it is assumed that the host currently establishing a connection to the USB hub device 120 is a host 110_1, and that a USB device 130_1 is a human interface device. In step S520, the connected host 110_1 controls the hub controller 122. When the connection to the host 110_1 is established, the hub controller 122 provides operation information of a human interface device (for example, the USB device 130_1) coupled to one of the DFP connectors DFP12_1 to DFP12_N to the host 110_1 through the multiplexer circuit 121. In response to a user performing a specified operation (for example, a specific operation method of at least one hotkey of a mouse or a keyboard) on the human interface device 130_1, the host 110_1 selectively determines whether to send a switching command to the hub controller 122 based on the operation information provided by the hub controller 122.

In response to the host 110_1 sending the switching command to the hub controller 122 through the multiplexer circuit 121 (i.e., the determination result of step S530 is “yes”), the hub controller 122 controls the multiplexer circuit 121 based on the switching command of the host 110_1 to terminate a connection between the host 110_1 and the hub controller 122, and the hub controller 122 controls the multiplexer circuit 121 to attempt to establish a connection to another host (for example, the host 110_M) through another UFP connector of the UFP connectors UFP12_1 to UFP12_M (step S540).

In response to the connection to another host (for example, the host 110_M) being successfully established (i.e., the determination result of step S550 is “yes”), the hub controller 122 is controlled by the new connected host 110_M (step S560). In response to the connection to another host being unsuccessfully established (i.e., the determination result of step S550 is “no”), the hub controller 122 controls the multiplexer circuit 121 to restore the connection between the original host (for example, the host 110_1) and the hub controller 122 (step S570).

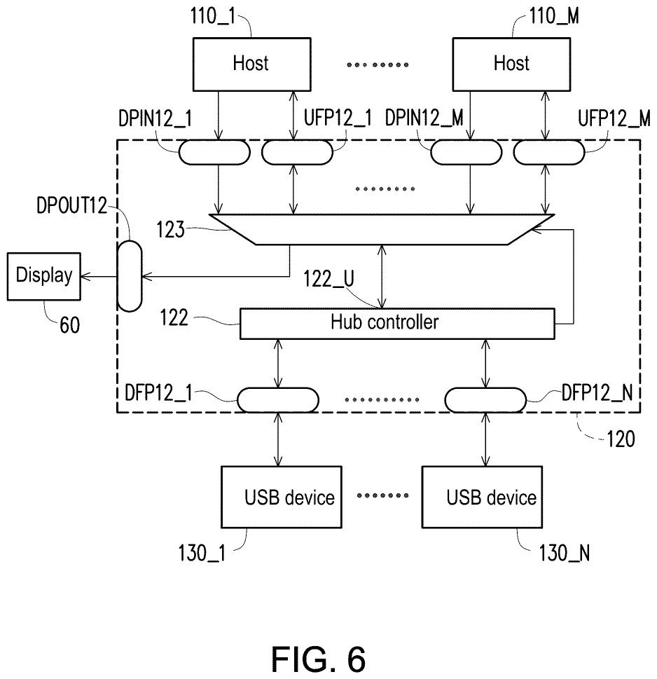

FIG. 6 is a circuit block diagram of a USB hub device 120 according to another embodiment of the disclosure. The hosts 110_1 to 110_M, the USB hub device 120, and the USB devices 130_1 to 130_N shown in FIG. 6 may be referred to the relevant descriptions of FIG. 1 and are not further described herein. The USB hub device 120 shown in FIG. 6 may serve as one of many implementation examples of the USB hub device 120 shown in FIG. 1. In the embodiment shown in FIG. 6, the USB hub device 120 includes UFP connectors UFP12_1 to UFP12_M, video input port connectors DPIN12_1 to DPIN12_M, a video output port connector DPOUT12, DFP connectors DFP12_1 to DFP12_N, a multiplexer circuit 123, and a hub controller 122. The UFP connectors UFP12_1 to UFP12_M, the DFP connectors DFP12_1 to DFP12_N, the multiplexer circuit 123, and the hub controller 122 shown in FIG. 6 may be referred to the relevant descriptions of the UFP connectors UFP12_1 to UFP12_M, the DFP connectors DFP12_1 to DFP12_N, the multiplexer circuit 121, and the hub controller 122 shown in FIG. 4, and are not further described herein.

The video input port connectors DPIN12_1 to DPIN12_M are one-to-one coupled to a plurality of video selection ports of the multiplexer circuit 123. The video input port connectors DPIN12_1 to DPIN12_M are configured to couple video output ports of different hosts 110_1 to 110_M. For example, the video output port of the host 110_1 is coupled to the video input port connector DPIN12_1, and the video output port of the host 110_M is coupled to the video input port connector DPIN12_M. The video output port connector DPOUT12 is coupled to a video common port of the multiplexer circuit 123. The video output port connector DPOUT12 is configured to couple a display 60.

In response to the connection between the host 110_1 and the hub controller 122 being established, the USB hub device 120 selectively couples the video input port connector DPIN12_1 to the video output port connector DPOUT12. For example, the hub controller 122 controls the multiplexer circuit 123 to selectively couple the video input port connector DPIN12_1 to the video output port connector DPOUT12, and the hub controller 122 controls the multiplexer circuit 123 to selectively couple the UFP connector UFP12_1 to the upstream facing port 122_U of the hub controller 122. By analogy, in response to the connection between the host 110_M and the hub controller 122 being established, the hub controller 122 of the USB hub device 120 controls the multiplexer circuit 123 to selectively couple the video input port connector DPIN12_M to the video output port connector DPOUT12, and the hub controller 122 controls the multiplexer circuit 123 to selectively couple the UFP connector UFP12_M to the upstream facing port 122_U of the hub controller 122.

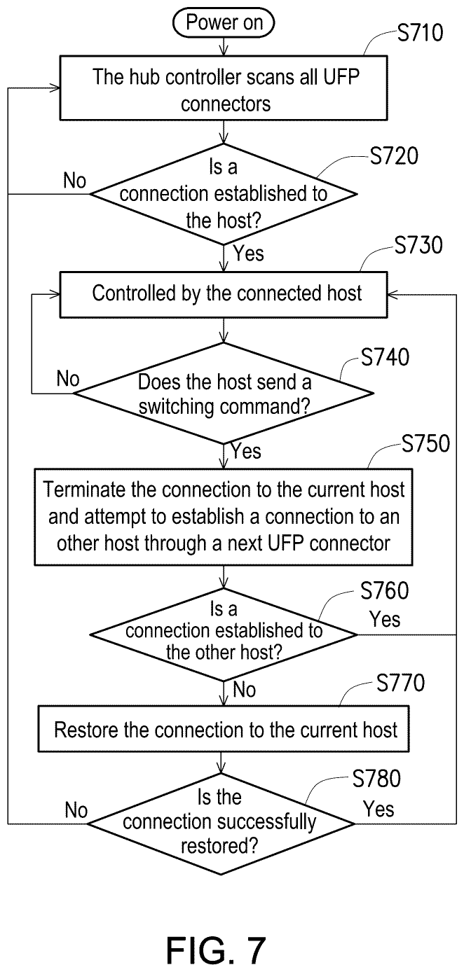

FIG. 7 is a flowchart of an operation method of the USB hub device 120 according to another embodiment of the disclosure. Referring to FIGS. 4 and 7, after being powered on, the hub controller 122 scans all UFP connectors UFP12_1 to UFP12_M through the multiplexer circuit 121 (step S710). Here, it is assumed that the host 110_1 is coupled to the UFP connector UFP12_1. Therefore, the hub controller 122 establishes a connection to the host 110_1 through the multiplexer circuit 121 and the UFP connector UFP12_1 (i.e., the determination result of step S720 is “yes”), and then the hub controller 122 is controlled by the connected host 110_1 (step S730).

In response to the host 110_1 sending a switching command to the hub controller 122 through the multiplexer circuit 121 (i.e., the determination result of step S740 is “yes”), the hub controller 122 controls the multiplexer circuit 121 based on the switching command of the host 110_1 to terminate the current connection between the host 110_1 and the hub controller 122, and the hub controller 122 controls the multiplexer circuit 121 to attempt to establish a connection to another host through a next UFP connector (step S750). In response to the connection to another host (for example, the host 110_M) being successfully established (i.e., the determination result of step S760 is “yes”), the hub controller 122 is controlled by the new connected host 110_M (step S730).

In the case that a connection between a new host (for example, the host 110_M) and the USB hub device 120 is established, in response to the host 110_M determining that the HID operation event meets the condition, the host 110_M selectively sends a switching command to the USB hub device 120. Based on the switching command sent by the host 110_M, the USB hub device 120 terminates a connection to the host 110_M and establishes a connection to another host. The other host is, for example, a third host not shown in FIG. 1, and the third host is coupled to a third UFP connector of the UFP connectors UFP12_1 to UFP12_M of the USB hub device 120 (not shown in FIG. 1).

For example, in the case that a connection between the new host (for example, the host 110_M) and the USB hub device 120 is established, the hub controller 122 provides an operation information of a human interface device coupled to one of the DFP connectors DFP12_1 to DFP12_N to the host 110_M through the multiplexer circuit 121. In response to a user performing a specified operation on the human interface device, the host 110_M selectively determines to send a switching command to the hub controller 122 based on the operation information provided by the hub controller 122. Based on the switching command sent by the host 110_M, the hub controller 122 controls the multiplexer circuit 121 to terminate a connection to the host 110_M and establish a connection to a third host (for example, the host 110_1 or another host).

In response to the connection to another host being unsuccessfully established (i.e., the determination result of step S760 is “no”), the hub controller 122 controls the multiplexer circuit 121 to restore a connection between the current host (for example, the host 110_1) and the hub controller 122 (step S770). In response to the connection to the host 110_1 being successfully restored (i.e., the determination result of step S780 is “yes”), the hub controller 122 returns to step S730 to continue being controlled by the connected host 110_1. In response to the connection to the host 110_1 being unsuccessfully restored (i.e., the determination result of step S780 is “no”), the hub controller 122 returns to step S710 to scan all UFP connectors UFP12_1 to UFP12_M again through the multiplexer circuit 121.

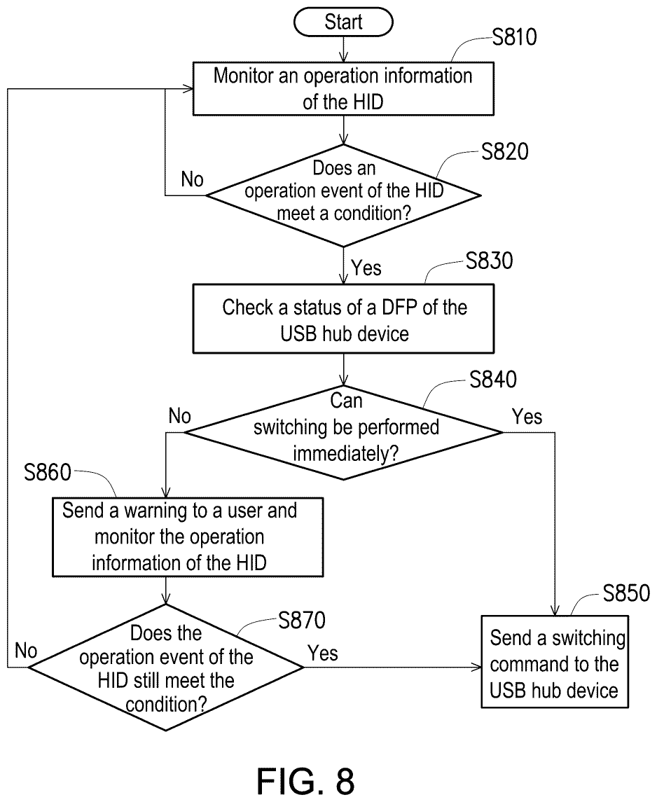

FIG. 8 is a flowchart of an operation method of a host according to an embodiment of the disclosure. Referring to FIGS. 1 and 8, it is assumed here that the host 110_1 establishes a connection with the hub controller 122. Software operating on the host 110_1 may monitor an operation information of a HID (human interface device, such as the USB device 130_1) coupled to the DFP connectors DFP12_1 to DFP12_N through the USB hub device 120 (step S810). The software of the host 110_1 may determine whether an HID operation event meets a condition. For example, the condition may be (but not limited to) “both left and right mouse buttons being held down at the same time for three seconds,” “a certain key of the keyboard (this key may be defined by the user) being tapped three times within one second,” or another condition.

In response to the current host (for example, the host 110_1) connected to the USB hub device 120 determining that the HID operation event does not meet the condition (i.e., the determination result of step S820 is “no”), the software operating on the host 110_1 returns to step S810 to continue monitoring the operation information of the HID (for example, the USB device 130_1). Generally, a USB host may send a query request to a USB device to obtain related information of the USB device. In response to the current host 110_1 connected to the USB hub device 120 determining that the HID operation event meets the condition (i.e., the determination result of step S820 is “yes”), the software of the host 110_1 sends a query command to the USB hub device 120 to acquire a connection status of the DFP connectors DFP12_1 to DFP12_N of the USB hub device 120 (step S830). Based on the connection status of the DFP connectors DFP12_1 to DFP12_N of the USB hub device 120, the host 110_1 determines whether to send a switching command to the USB hub device 120 to immediately switch the host (step S840). For example, the host 110_1 checks whether any of the DFP connectors DFP12_1 to DFP12_N is coupled to a non-human interface device (non-HID), such as a flash drive, solid-state drive, and so on. If none of the DFP connectors DFP12_1 to DFP12_N is coupled to a non-human interface device, then the determination result of step S840 is “yes.” If any of the DFP connectors DFP12_1 to DFP12_N is coupled to a non-human interface device, then the determination result of step S840 is “no.”

In response to the host 110_1 determining that the USB hub device 120 may immediately switch the host (i.e., the determination result of step S840 is “yes,” for example, in response to a connection status of the DFP connectors DFP12_1 to DFP12_N indicating that each of the DFP connectors DFP12_1 to DFP12_N is not connected to a non-human interface device), the current host (for example, the host 110_1) connected to the USB hub device 120 sends a switching command to the USB hub device 120 (step S850). Based on the switching command sent by the host 110_1, the USB hub device 120 terminates a connection to the host 110_1, and the USB hub device 120 establishes a connection to another host (for example, the host 110_M).

In response to the connection status of the DFP connectors DFP12_1 to DFP12_N indicating that any one of the DFP connectors DFP12_1 to DFP12_N is connected to a non-human interface device (i.e., the determination result of step S840 is “no”), the host 110_1 sends a warning to a user (step S860). After sending the warning to the user, software operating on the host 110_1 continues to monitor, through the USB hub device 120, an operation information of a HID (human interface device, such as the USB device 130_1) coupled to the DFP connectors DFP12_1 to DFP12_N (step S860). In response to the HID operation event still meeting the condition (i.e., the determination result of step S870 is “yes,” indicating that the user agrees to force the USB hub device 120 to switch the host), the host 110_1 sends a switching command to the USB hub device 120 (step S850). Based on the switching command sent by the host 110_1, the USB hub device 120 terminates a connection to the host 110_1, and the USB hub device 120 establishes a connection to another host (for example, the host 110_M). In response to the HID operation event changing to not meeting the condition (i.e., the determination result of step S870 is “no”), the software operating on the host 110_1 returns to step S810 to continue monitoring an operation information of the HID (for example, the USB device 130_1).

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A switching system, comprising:
a universal serial bus (USB) hub device, comprising a plurality of upstream facing port connectors and a plurality of downstream facing port connectors, wherein the plurality of upstream facing port connectors are configured to couple a plurality of different hosts, and each of the plurality of downstream facing port connectors is configured to couple a human interface device, a USB device, or another USB hub device; and
a first host, coupled to a first upstream facing port connector of the plurality of upstream facing port connectors of the USB hub device, wherein
in response to the first host determining that a human interface device operation event meets a condition, the first host selectively sends a first switching command to the USB hub device; and
based on the first switching command sent by the first host, the USB hub device terminates a connection to the first host and establishes a connection to a second host, wherein the second host is coupled to a second upstream facing port connector of the plurality of upstream facing port connectors of the USB hub device.

2. The switching system according to claim 1, wherein
when the connection to the first host is established, the USB hub device provides an operation information of the human interface device coupled to one of the plurality of downstream facing port connectors to the first host, and
in response to a user performing a specified operation on the human interface device coupled to one of the plurality of downstream facing port connectors of the USB hub device, the first host determines that the human interface device operation event meets the condition.

3. The switching system according to claim 2, wherein the specified operation comprises a specific operation method of at least one hotkey of a mouse or a keyboard.

4. The switching system according to claim 1, wherein
based on the first switching command, the USB hub device checks whether another upstream facing port connector other than the first upstream facing port connector of the plurality of upstream facing port connectors of the USB hub device is coupled to another host;
in response to the another host being coupled to the another upstream facing port connector of the USB hub device, the USB hub device terminates the connection to the first host and establishes a connection to the another host based on the first switching command; and
in response to no host being coupled to any upstream facing port connector other than the first upstream facing port connector of the plurality of upstream facing port connectors of the USB hub device, the USB hub device maintains a connection between the first host and the first upstream facing port connector.

5. The switching system according to claim 1, wherein
the USB hub device terminates a connection between the first host and the first upstream facing port connector and attempts to establish a connection to the second host through the second upstream facing port connector based on the first switching command sent by the first host;
in response to the connection to the second host being successfully established, the USB hub device is controlled by the connected second host; and
in response to the connection to the second host being unsuccessfully established, the USB hub device restores the connection between the first host and the first upstream facing port connector.

6. The switching system according to claim 1, wherein the USB hub device further comprises a plurality of video input port connectors and a video output port connector, the video output port connector of the USB hub device is configured to couple a display, the plurality of video input port connectors of the USB hub device are configured to couple a plurality of video output ports of a plurality of different hosts, the video output port of the first host is coupled to a first video input port connector of the plurality of video input port connectors, and the video output port of the second host is coupled to a second video input port connector of the plurality of video input port connectors, and
in response to a connection between the first host and the first upstream facing port connector being established, the USB hub device selectively couples the first video input port connector of the USB hub device to the video output port connector of the USB hub device; and
in response to a connection between the second host and the second upstream facing port connector being established, the USB hub device selectively couples the second video input port connector of the USB hub device to the video output port connector of the USB hub device.

7. The switching system according to claim 1, wherein the USB hub device comprises:
the plurality of upstream facing port connectors;
the plurality of downstream facing port connectors;
a multiplexer circuit, wherein a plurality of USB selection ports of the multiplexer circuit are one-to-one coupled to the plurality of upstream facing port connectors; and
a hub controller, wherein an upstream facing port of the hub controller is coupled to a USB common port of the multiplexer circuit, a plurality of downstream facing ports of the hub controller are one-to-one coupled to the plurality of downstream facing port connectors, and the hub controller controls the multiplexer circuit to selectively couple one of the plurality of upstream facing port connectors to the upstream facing port of the hub controller, wherein
in response to the first host sending the first switching command to the hub controller through the multiplexer circuit, the hub controller controls the multiplexer circuit based on the first switching command to terminate a connection between the first host and the hub controller, and the hub controller controls the multiplexer circuit to attempt to establish a connection to the second host through the second upstream facing port connector;
in response to the connection to the second host being successfully established, the hub controller is controlled by the connected second host; and
in response to the connection to the second host being unsuccessfully established, the hub controller controls the multiplexer circuit to restore the connection between the first host and the hub controller.

8. The switching system according to claim 7, wherein the USB hub device further comprises:
a plurality of video input port connectors, configured to couple a plurality of video output ports of a plurality of different hosts, wherein the plurality of video input port connectors are one-to-one coupled to a plurality of video selection ports of the multiplexer circuit, the video output port of the first host is coupled to a first video input port connector of the plurality of video input port connectors, and the video output port of the second host is coupled to a second video input port connector of the plurality of video input port connectors; and
a video output port connector, configured to couple a display, wherein the video output port connector is coupled to a video common port of the multiplexer circuit,
in response to a connection between the first host and the hub controller being established, the hub controller controls the multiplexer circuit to selectively couple the first video input port connector to the video output port connector; and
in response to a connection between the second host and the hub controller being established, the hub controller controls the multiplexer circuit to selectively couple the second video input port connector to the video output port connector.

9. The switching system according to claim 1, wherein
the first host monitors an operation information of the human interface device coupled to one of the plurality of downstream facing port connectors through the USB hub device;
in response to the operation information of the human interface device indicating that the human interface device operation event meets the condition, the first host sends a query command to the USB hub device to acquire a connection status of the plurality of downstream facing port connectors of the USB hub device; and
based on the connection status of the plurality of downstream facing port connectors of the USB hub device, the first host determines whether to send the first switching command to the USB hub device.

10. The switching system according to claim 9, wherein
in response to the connection status of the plurality of downstream facing port connectors indicating that each of the plurality of downstream facing port connectors of the USB hub device is not connected to a non-human interface device, the first host sends the first switching command to the USB hub device;
in response to the connection status of the plurality of downstream facing port connectors indicating that any one of the plurality of downstream facing port connectors of the USB hub device is connected to a non-human interface device, the first host sends a warning to a user; and
after sending the warning to the user, in response to the human interface device operation event still meeting the condition, the first host sends the first switching command to the USB hub device.

11. The switching system according to claim 1, wherein
when a connection between the second host and the second upstream facing port connector is established, in response to the second host determining that the human interface device operation event meets the condition, the second host selectively sends a second switching command to the USB hub device; and
based on the second switching command sent by the second host, the USB hub device terminates a connection to the second host and establishes a connection to a third host, wherein the third host is coupled to a third upstream facing port connector of the plurality of upstream facing port connectors of the USB hub device.

12. An operation method of a switching system, comprising:
in response to a first host of the switching system determining that a human interface device operation event meets a condition, the first host selectively sending a first switching command to a USB hub device of the switching system, wherein the USB hub device comprises a plurality of upstream facing port connectors and a plurality of downstream facing port connectors, the plurality of upstream facing port connectors are configured to couple a plurality of different hosts, each of the plurality of downstream facing port connectors is configured to couple a human interface device, a USB device, or another USB hub device, and the first host is coupled to a first upstream facing port connector of the plurality of upstream facing port connectors of the USB hub device; and
based on the first switching command sent by the first host, the USB hub device terminating a connection to the first host and establishing a connection to a second host, wherein the second host is coupled to a second upstream facing port connector of the plurality of upstream facing port connectors of the USB hub device.

13. The operation method according to claim 12, further comprising:
when the connection to the first host is established, the USB hub device providing an operation information of the human interface device coupled to one of the plurality of downstream facing port connectors to the first host, and
in response to a user performing a specified operation on the human interface device coupled to one of the plurality of downstream facing port connectors of the USB hub device, the first host determining that the human interface device operation event meets the condition.

14. The operation method according to claim 13, wherein the specified operation comprises a specific operation method of at least one hotkey of a mouse or a keyboard.

15. The operation method according to claim 12, further comprising:
based on the first switching command, the USB hub device checking whether another upstream facing port connector other than the first upstream facing port connector of the plurality of upstream facing port connectors of the USB hub device is coupled to another host; wherein
in response to the another host being coupled to the another upstream facing port connector of the USB hub device, the USB hub device terminates the connection to the first host and establishing a connection to the another host based on the first switching command; and
in response to no host being coupled to any upstream facing port connector other than the first upstream facing port connector of the plurality of upstream facing port connectors of the USB hub device, the USB hub device maintains a connection between the first host and the first upstream facing port connector.

16. The operation method according to claim 12, further comprising:
based on the first switching command sent by the first host, the USB hub device terminating a connection between the first host and the first upstream facing port connector, and the USB hub device attempting to establish a connection to the second host through the second upstream facing port connector; wherein
in response to the connection to the second host being successfully established, the USB hub device is controlled by the connected second host; and
in response to the connection to the second host being unsuccessfully established, the USB hub device restores the connection between the first host and the first upstream facing port connector.

17. The operation method according to claim 12, wherein the USB hub device further comprises a plurality of video input port connectors and a video output port connector, the video output port connector of the USB hub device is configured to couple a display, the plurality of video input port connectors of the USB hub device are configured to couple a plurality of video output ports of a plurality of different hosts, the video output port of the first host is coupled to a first video input port connector of the plurality of video input port connectors, and the video output port of the second host is coupled to a second video input port connector of the plurality of video input port connectors, the operation method further comprising:
in response to a connection between the first host and the first upstream facing port connector being established, the USB hub device selectively coupling the first video input port connector of the USB hub device to the video output port connector of the USB hub device; and
in response to a connection between the second host and the second upstream facing port connector being established, the USB hub device selectively coupling the second video input port connector of the USB hub device to the video output port connector of the USB hub device.

18. The operation method according to claim 12, further comprising:
in response to the first host sending the first switching command to a hub controller of the USB hub device through a multiplexer circuit of the USB hub device, the hub controller controlling the multiplexer circuit based on the first switching command to terminate a connection between the first host and the hub controller, and the hub controller controlling the multiplexer circuit to attempt to establish a connection to the second host through the second upstream facing port connector, wherein a plurality of USB selection ports of the multiplexer circuit are one-to-one coupled to the plurality of upstream facing port connectors, an upstream facing port of the hub controller is coupled to a USB common port of the multiplexer circuit, and a plurality of downstream facing ports of the hub controller are one-to-one coupled to the plurality of downstream facing port connectors;
the hub controller controlling the multiplexer circuit to selectively couple one of the plurality of upstream facing port connectors to the upstream facing port of the hub controller; wherein
in response to the connection to the second host being successfully established, the hub controller is controlled by the connected second host; and
in response to the connection to the second host being unsuccessfully established, the hub controller controls the multiplexer circuit to restore the connection between the first host and the hub controller.

19. The operation method according to claim 18, wherein the USB hub device further comprises a plurality of video input port connectors and a video output port connector, and the operation method further comprises:
in response to a connection between the first host and the hub controller being established, the hub controller controlling the multiplexer circuit to selectively couple a first video input port connector of the plurality of video input port connectors to the video output port connector, wherein the plurality of video input port connectors are configured to couple a plurality of video output ports of a plurality of different hosts, the plurality of video input port connectors are one-to-one coupled to a plurality of video selection ports of the multiplexer circuit, the video output port of the first host is coupled to the first video input port connector, the video output port of the second host is coupled to a second video input port connector of the plurality of video input port connectors, the video output port connector is configured to couple a display, and the video output port connector is coupled to a video common port of the multiplexer circuit; and
in response to a connection between the second host and the hub controller being established, the hub controller controlling the multiplexer circuit to selectively couple the second video input port connector to the video output port connector.

20. The operation method according to claim 12, further comprising:
the first host monitoring an operation information of the human interface device coupled to one of the plurality of downstream facing port connectors through the USB hub device;
in response to the operation information of the human interface device indicating that the human interface device operation event meets the condition, the first host sending a query command to the USB hub device to acquire a connection status of the plurality of downstream facing port connectors of the USB hub device; and
based on the connection status of the plurality of downstream facing port connectors of the USB hub device, the first host determining whether to send the first switching command to the USB hub device.

21. The operation method according to claim 20, further comprising:
in response to the connection status of the plurality of downstream facing port connectors indicating that each of the plurality of downstream facing port connectors of the USB hub device is not connected to a non-human interface device, the first host sending the first switching command to the USB hub device;
in response to the connection status of the plurality of downstream facing port connectors indicating that any one of the plurality of downstream facing port connectors of the USB hub device is connected to a non-human interface device, the first host sending a warning to a user; and
after sending the warning to the user, in response to the human interface device operation event still meeting the condition, the first host sending the first switching command to the USB hub device.

22. The operation method according to claim 12, further comprising:
when a connection between the second host and the second upstream facing port connector is established, in response to the second host determining that the human interface device operation event meets the condition, the second host selectively sending a second switching command to the USB hub device; and
based on the second switching command sent by the second host, the USB hub device terminating a connection to the second host and establishing a connection to a third host, wherein the third host is coupled to a third upstream facing port connector of the plurality of upstream facing port connectors of the USB hub device.

23. A USB hub device, comprising:
a plurality of upstream facing port connectors, wherein the plurality of upstream facing port connectors are configured to couple a plurality of different hosts;
a plurality of downstream facing port connectors, wherein each of the plurality of downstream facing port connectors is configured to couple a human interface device, a USB device, or another USB hub device;
a multiplexer circuit, wherein a plurality of USB selection ports of the multiplexer circuit are one-to-one coupled to the plurality of upstream facing port connectors; and
a hub controller, wherein an upstream facing port of the hub controller is coupled to a USB common port of the multiplexer circuit, a plurality of downstream facing ports of the hub controller are one-to-one coupled to the plurality of downstream facing port connectors, and the hub controller controls the multiplexer circuit to selectively couple one of the plurality of upstream facing port connectors to the upstream facing port of the hub controller, wherein
in response to a first host coupled to a first upstream facing port connector of the plurality of upstream facing port connectors sending a first switching command to the hub controller through the multiplexer circuit, the hub controller controls the multiplexer circuit based on the first switching command to terminate a connection between the first host and the hub controller, and the hub controller controls the multiplexer circuit to attempt to establish a connection to a second host through a second upstream facing port connector of the plurality of upstream facing port connectors;
in response to the connection to the second host being successfully established, the hub controller is controlled by the connected second host; and
in response to the connection to the second host being unsuccessfully established, the hub controller controls the multiplexer circuit to restore the connection between the first host and the hub controller.

24. The USB hub device according to claim 23, wherein
when a connection to the first host is established, the hub controller provides an operation information of the human interface device coupled to one of the plurality of downstream facing port connectors to the first host through the multiplexer circuit; and
in response to a user performing a specified operation on the human interface device, the first host selectively determines to send the first switching command to the hub controller based on the operation information provided by the hub controller.

25. The USB hub device according to claim 24, wherein the specified operation comprises a specific operation method of at least one hotkey of a mouse or a keyboard.

26. The USB hub device according to claim 23, further comprising:
a plurality of video input port connectors, configured to couple a plurality of video output ports of a plurality of different hosts, wherein the plurality of video input port connectors are one-to-one coupled to a plurality of video selection ports of the multiplexer circuit, the video output port of the first host is coupled to a first video input port connector of the plurality of video input port connectors, and the video output port of the second host is coupled to a second video input port connector of the plurality of video input port connectors; and
a video output port connector, configured to couple a display, wherein the video output port connector is coupled to a video common port of the multiplexer circuit,
in response to a connection between the first host and the hub controller being established, the hub controller controls the multiplexer circuit to selectively couple the first video input port connector to the video output port connector; and
in response to a connection between the second host and the hub controller being established, the hub controller controls the multiplexer circuit to selectively couple the second video input port connector to the video output port connector.

27. The USB hub device according to claim 23, wherein
when a connection between the second host and the second upstream facing port connector is established, the hub controller provides an operation information of the human interface device coupled to one of the plurality of downstream facing port connectors to the second host through the multiplexer circuit;
in response to a user performing a specified operation on the human interface device, the second host selectively determines to send a second switching command to the hub controller based on the operation information provided by the hub controller; and
based on the second switching command sent by the second host, the hub controller controls the multiplexer circuit to terminate a connection to the second host and establish a connection to a third host, wherein the third host is coupled to a third upstream facing port connector of the plurality of upstream facing port connectors of the USB hub device.

28. An operation method of a USB hub device, comprising:
a hub controller of the USB hub device controlling a multiplexer circuit of the USB hub device to selectively couple one of a plurality of upstream facing port connectors of the USB hub device to an upstream facing port of the hub controller, wherein the plurality of upstream facing port connectors are configured to couple a plurality of different hosts, each of a plurality of downstream facing port connectors of the USB hub device is configured to couple a human interface device, a USB device, or another USB hub device, a plurality of USB selection ports of the multiplexer circuit are one-to-one coupled to the plurality of upstream facing port connectors, the upstream facing port of the hub controller is coupled to a USB common port of the multiplexer circuit, and a plurality of downstream facing ports of the hub controller are one-to-one coupled to the plurality of downstream facing port connectors;
in response to a first host coupled to a first upstream facing port connector of the plurality of upstream facing port connectors sending a first switching command to the hub controller through the multiplexer circuit, the hub controller controlling the multiplexer circuit based on the first switching command to terminate a connection between the first host and the hub controller, and the hub controller controlling the multiplexer circuit to attempt to establish a connection to a second host through a second upstream facing port connector of the plurality of upstream facing port connectors; wherein
in response to the connection to the second host being successfully established, the hub controller is controlled by the connected second host; and
in response to the connection to the second host being unsuccessfully established, the hub controller controls the multiplexer circuit to restore the connection between the first host and the hub controller.

29. The operation method according to claim 28, further comprising:
when a connection to the first host is established, the hub controller providing an operation information of the human interface device coupled to one of the plurality of downstream facing port connectors to the first host through the multiplexer circuit,
wherein in response to a user performing a specified operation on the human interface device, the first host selectively determines to send the first switching command to the hub controller based on the operation information provided by the hub controller.

30. The operation method according to claim 29, wherein the specified operation comprises a specific operation method of at least one hotkey of a mouse or a keyboard.

31. The operation method according to claim 28, wherein the USB hub device further comprises a plurality of video input port connectors and a video output port connector, the plurality of video input port connectors are configured to couple a plurality of video output ports of a plurality of different hosts, the plurality of video input port connectors are one-to-one coupled to a plurality of video selection ports of the multiplexer circuit, the video output port of the first host is coupled to a first video input port connector of the plurality of video input port connectors, the video output port of the second host is coupled to a second video input port connector of the plurality of video input port connectors, the video output port connector is configured to couple a display, and the video output port connector is coupled to a video common port of the multiplexer circuit, the operation method further comprising:
in response to a connection between the first host and the hub controller being established, the hub controller controlling the multiplexer circuit to selectively couple the first video input port connector to the video output port connector; and
in response to a connection between the second host and the hub controller being established, the hub controller controlling the multiplexer circuit to selectively couple the second video input port connector to the video output port connector.

32. The operation method according to claim 28, further comprising:
when a connection between the second host and the second upstream facing port connector is established, the hub controller providing an operation information of the human interface device coupled to one of the plurality of downstream facing port connectors to the second host through the multiplexer circuit, wherein in response to a user performing a specified operation on the human interface device, the second host selectively determines to send a second switching command to the hub controller based on the operation information provided by the hub controller; and
based on the second switching command sent by the second host, the hub controller controlling the multiplexer circuit to terminate a connection to the second host and establish a connection to a third host, wherein the third host is coupled to a third upstream facing port connector of the plurality of upstream facing port connectors of the USB hub device.
